(19) United States
(12) Patent Application Publication
(10) Pub. No.: US 2001/0025557 A1
(43) Pub. Date: Oct. 4, 2001

(54) Compound punching apparatus

(76) Inventors: Carlton G. Jenkins, Sugar Grove, PA (US); David R. Hurst, Manalapan, FL (US)

Correspondence Address: David L. Principe, Hodgson Russ LLP, One M&T Plaza, Suite 2000, Buffalo, NY, 14203-2391, US

(21) Appl. No.: 09/876,815

(22) Filed: Jun. 7, 2001

Related U.S. Application Data
(62) Division of application No. 09/276,079, filed on Mar. 25, 1999.

(51) Int. Cl. B26F 1/02; B26D 7/06

(52) U.S. Cl. 83/685; 83/226; 83/277

(57) ABSTRACT

A compound punching apparatus for providing a substrate having half of the perforations formed from one major surface of the substrate and the other half of the perforations formed from the opposite major surface. The arrangement of the punches create equal and opposite stress forces in the substrate that essentially cancel each other out to provide a product meeting exacting planarity requirements. The compound punching apparatus includes two diametrically opposed dies and punching tools, a feed system, a drive system and a frame.

### FIELD OF THE INVENTION

The present invention generally relates to a compound punching apparatus, and more particularly to a compound punching apparatus for perforating a planar, electrically conductive substrate suitable for use in producing a current collector in an electrochemical cell.

### BACKGROUND OF THE INVENTION

It is known to form perforated substrates from a sheet of electrically conductive material wherein the perforations are punched or otherwise introduced from one side only. The problem with this type of punching is that the resultant burrs formed on the opposite side at each of the perforations introduce stress forces into the substrate that cause it to bow. Conventionally, the bow is removed from the perforated substrate by pressing out the burrs. However, as the width of the substrate increases, the difficulty of compensating for the bow is magnified.

During battery manufacture, it is extremely critical that the substrate current collector be as planar as possible to allow for high speed lamination of the electrode active material onto the substrate. However, it is often difficult to adequately press out the burrs to provide an acceptably planar substrate, and pressing the substrate to remove the bow from a perforated substrate adds an extra step to the manufacturing process. A substrate having perforations formed from opposing major surfaces is disclosed and claimed in U.S. Pat. No. 5,578,398, which is hereby incorporated by reference.

Coating, laminating and other processes normally limit how fast the substrates can be processed. To increase the throughput while holding the speed constant, wider materials must be passed through the system. Wider materials are more difficult to maintain flat and the chances of cross bow increase with the increased width. Accordingly, there is a need for a punching apparatus that minimizes the risk of crossbow and produces a perforated substrate that conforms to strict planarity requirements.

### SUMMARY OF THE INVENTION

The present invention meets the above described need by providing a compound punching apparatus that punches the substrate from opposite sides of the substrate in alternating fashion. By uniformly alternating the perforations in this manner, the stress forces produced at each perforation are essentially canceled by the adjacent perforation formed through the opposite major surface of the substrate and the substrate maintains an extremely planar shape.

The present invention provides a compound punching apparatus for providing a perforated material having first and second major surfaces. The apparatus includes a frame for maintaining all of the elements substantially square relative to the material. A pair of punching tools are mounted to the frame and are disposed opposite from each other. The punching tools include a set of punches mounted to a punch ram. The punching tool is attached to a slide that slides back and forth inside a set of gibs. The gibs maintain the slides and the punches in their proper alignment relative to the material. A pair of dies are mounted to the frame opposite to each other. The dies have openings that correspond to the punching tools such that the punching tools pass through the dies into the substrate on their punching stroke. The first die is stationary and the second dies moves toward and away from the first die such that the dies are disposed in spaced apart relation for a portion of the cycle and are disposed in juxtaposition for another portion of the cycle. In this manner, the moving die acts as a stripper.

A feed mechanism in the form of a pair of grippers advances the material through the system. Each of the grippers includes a feed bar and a clamp. When the clamp is closed and the feed bar is moving, the gripper conveys the material. During this feed cycle, the other gripper is moving in the opposite direction with its clamp open to reposition prior to its next feed. In this manner, the grippers feed in alternating fashion and are always in position for their next feed. As a result, there is no dead time in the cycle associated with repositioning the feed bars.

Other features and advantages of the present invention will become apparent upon reading the following detailed description of embodiments of the invention, when taken in conjunction with the accompanying drawings and the appended claims.

### BRIEF DESCRIPTION OF THE DRAWINGS

The invention is illustrated in the drawings in which like reference characters designate the same or similar parts throughout the figures of which:

FIG. 1 is a side elevation view of the apparatus of the present invention;

FIG. 2 is a partial side elevation of the apparatus shown in FIG. 1;

FIG. 3 is a top plan view of the apparatus;

FIG. 4 is a schematic diagram of the drive system of the present invention;

FIG. 5 is a side elevation view of the cam shaft and stripper mechanism of the present invention;

FIG. 6A is a sectional view taken along line 6-6 of FIG. 5;

FIG. 6B is a side view of the eccentric, the roller bearing and the collar, that moves the punch plate;

FIG. 7 is a sectional view taken along line 7-7 of FIG. 3;

FIG. 8 is a sectional view taken along line 8-8 of FIG. 7;

FIG. 9 is a sectional view taken along line 9-9 of FIG. 8;

FIG. 10 is a top plan view of the feed system;

FIG. 11 is a sectional view taken along line 11-11 of FIG. 10;

FIG. 12 is an enlarged, partial side elevation view of the feed system of the present invention;

FIG. 13 is a front elevational view of the feed system of the present invention;

FIG. 14 is a partial side elevation view of the present invention;

FIG. 15 is a timing diagram for the present invention;

FIG. 16 is a partial, plan view of a perforated substrate according to the present invention; and,

FIG. 17 is a cross-sectional view taken along line 17-17 of FIG. 16.

### DETAILED DESCRIPTION OF THE PREFERRED EMBODIMENT

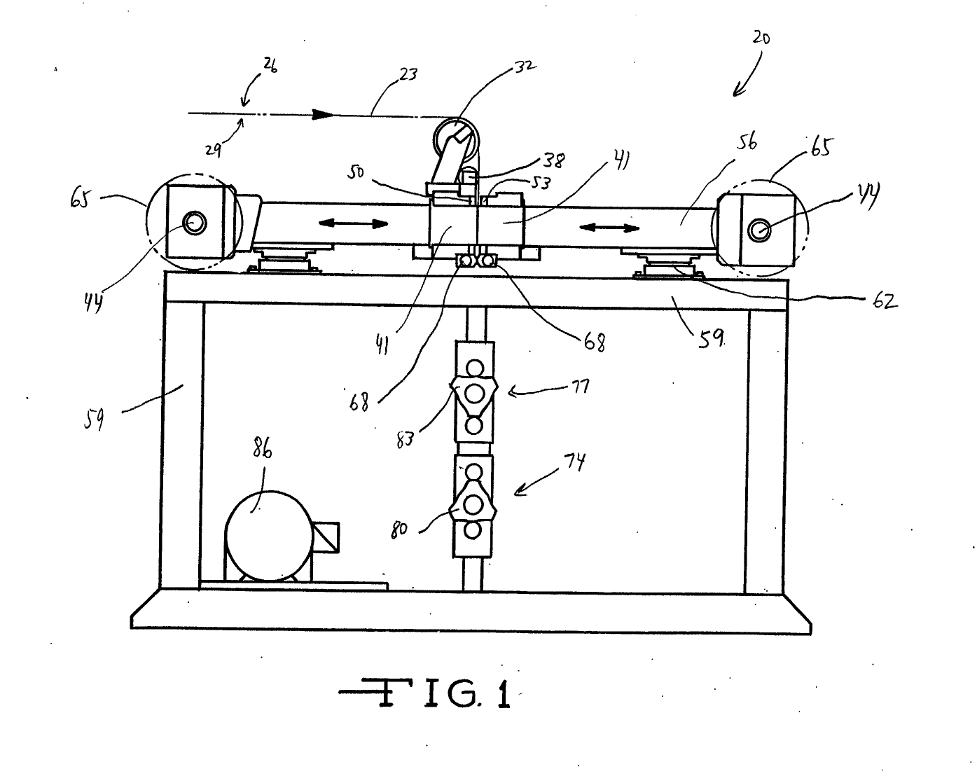

In FIG. 1, a compound punching apparatus 20 perforates a thin sheet of material 23 from opposite sides of the material 23. Approximately half of the perforations are formed from one major surface 26 of the material 23, and the other half of the perforations are formed from the other major surface 29. The material 23 is a planar sheet of thin gauge material that is substantially flat. For example, the sheet may be an electrically conductive, thin metal sheet suitable for use as a current collector in a battery. Accordingly, the thin material is perforated to form a substrate. The perforated substrate is then laminated with an electrode active material. The invention is also suitable for other applications where thin materials susceptible to crossbow need to be perforated and maintained as flat as possible, for example, some components of microcomputers would be suitable.

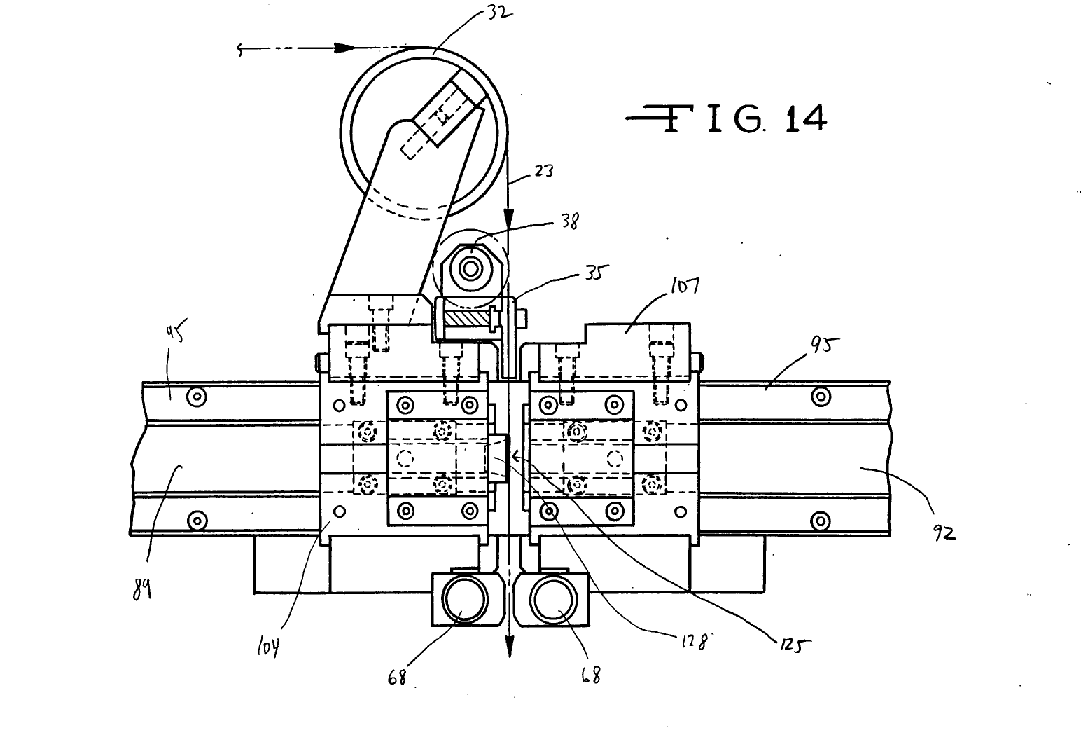

The thin material 23 is normally stored in rolls of flat sheets having a predetermined width corresponding to the maximum width suitable for processing in the compound punching apparatus 20. The material 23 unwinds from the roll (not shown) and a loop control system (not shown) is typically used to isolate the compound punching apparatus 20 from any tension due to the roll. In order to do so, as known by those of ordinary skill in the art, the loop control apparatus controls the unwinding of the material by means of an electric eye such that enough slack is maintained between the roller and the apparatus 20 so that the only tension upstream is due to the weight of the material 23. The material 23 enters the apparatus 20 across a fixed roller 32 that is made of a material having a minimum frictional effect on the material 23. The material 23 is provided with edge guidance as it enters the punching apparatus 20 as is known to those of ordinary skill in the art. A coarse adjustment is accomplished by edge guides 35 (FIG. 14) that physically border the edges of the material 23. Fine adjustment is provided by a lead screw that provides for fine tuning by turning a knob 38 to advance a carriage.

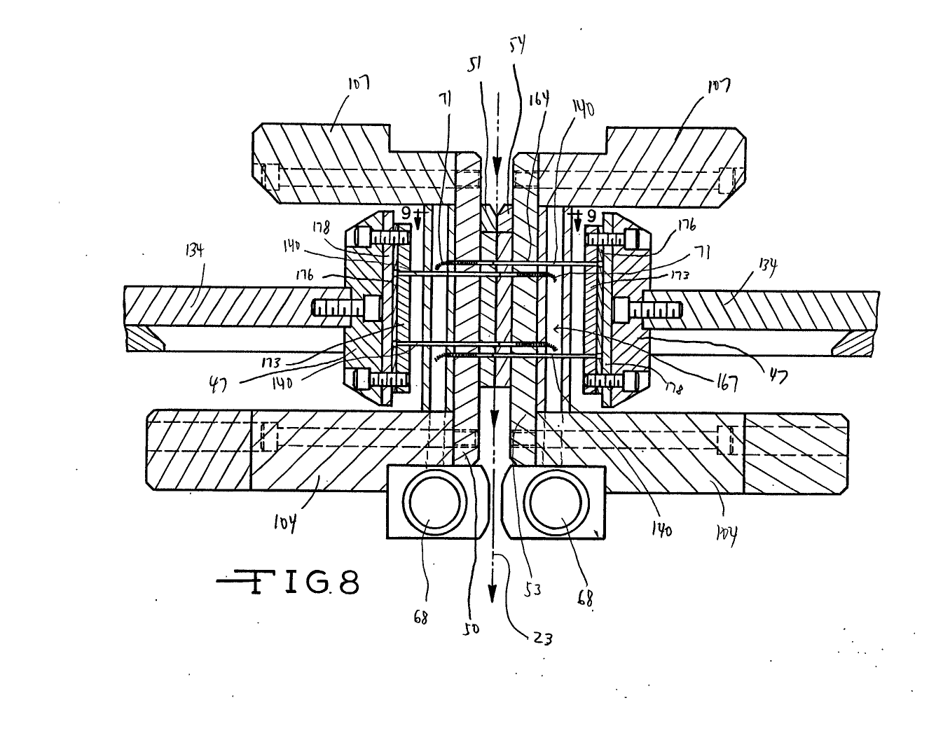

The material 23 passes between two sets of tooling 41 positioned on opposite sides. Each set of tooling 41 is controlled by a cam shaft 44. The tooling 41 primarily includes a pair of punch rams 47 (FIG. 9), a pair of die mounting plates 50 and 53 (FIG. 9), and a set of dies 51, 54 (FIG. 9). The tooling 41 is mounted to a subframe 56 that is mounted to the main frame 59 by isolation pads 62. A set of hand wheels 65 provide for manual rotation of the cam shafts 44 for threading the machine and the like. The left side of the tooling 41 has a fixed die mounting plate 50. Die plate 53 acts as a stripper and moves toward and away from die plate 50 according to the cycle of the apparatus 20.

A pair of horizontal slug evacuation tubes 68 attach to a manifold that is connected to a centrifugal blower (not shown) for vacuum conveying the slugs 71 (shown in FIG. 8) for disposal.

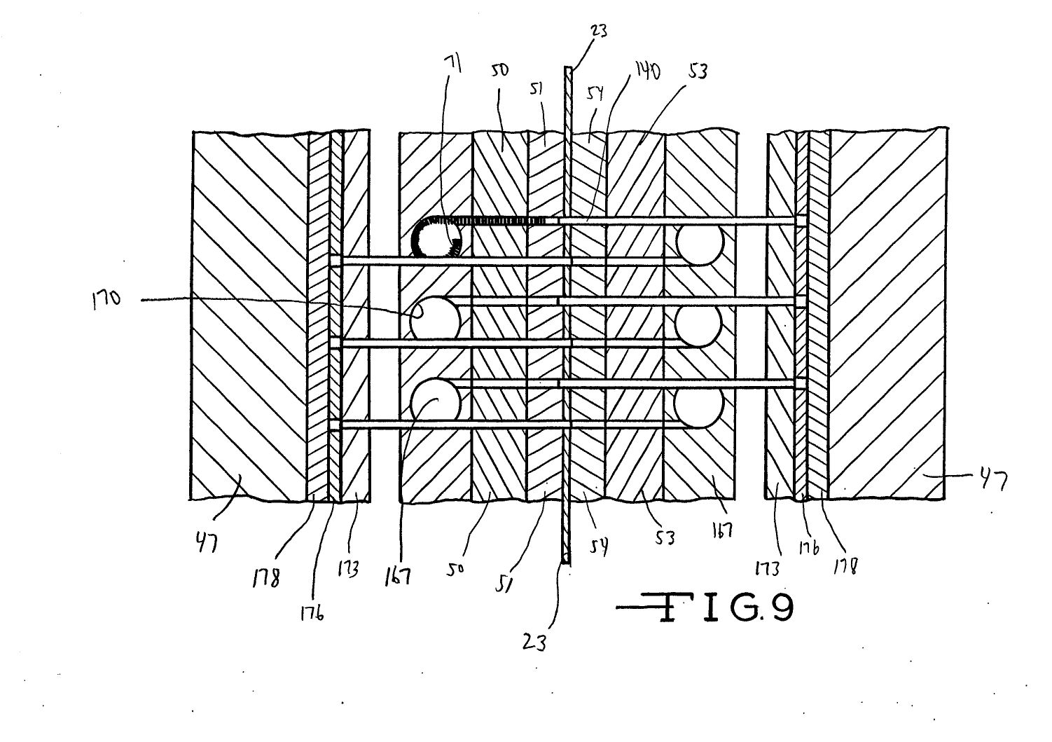

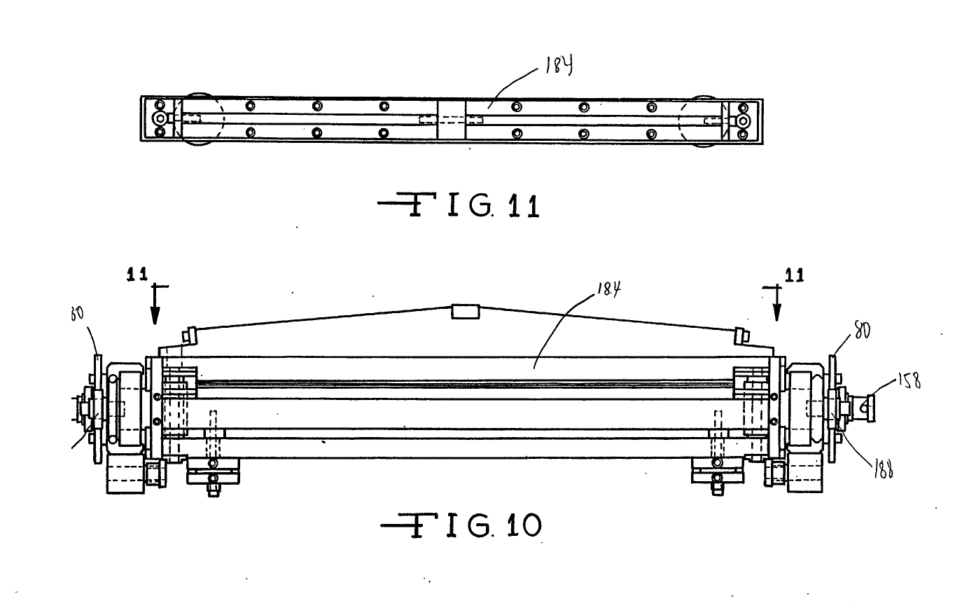

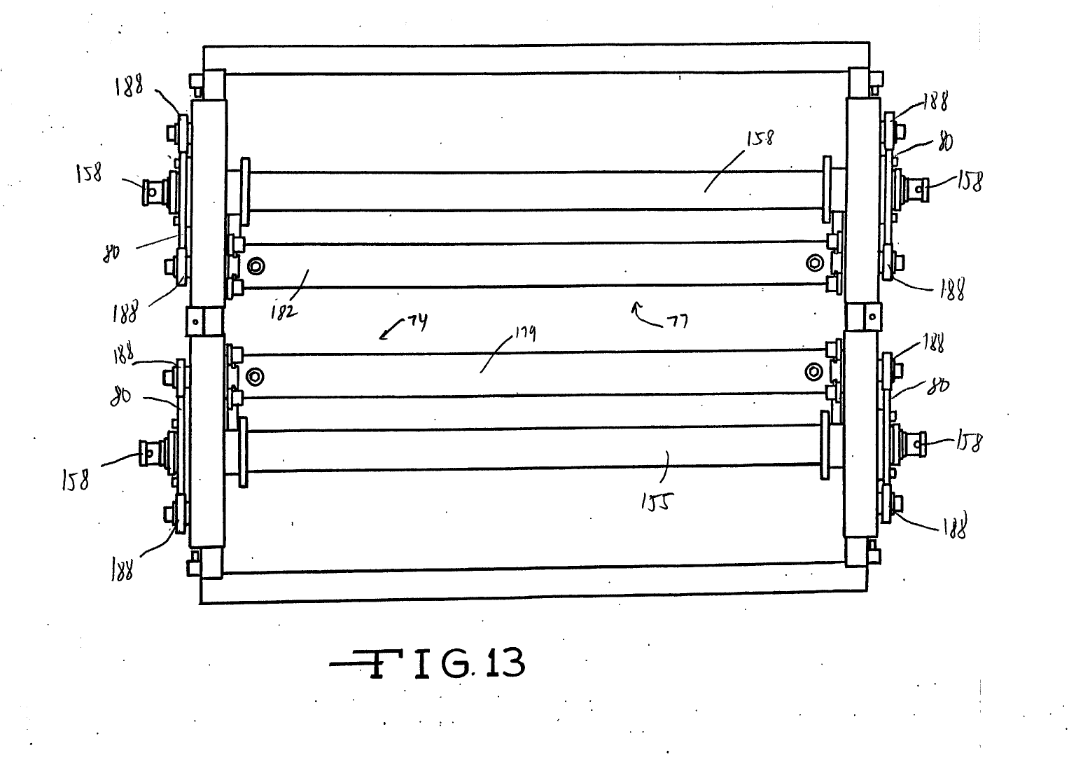

The material 23 is conveyed through the apparatus 20 by a pair of grippers 74, 77 that advance the material 23 through the apparatus. A pair of tricoidal cams 80, 83 control the positioning of each gripper 74, 77, as will be described in detail with reference to FIGS. 10-13.

A single electric motor 86 preferably drives all of the shafts. The motor 86 is preferably a 5 HP DC drive, variable speed motor. Other types of motors for driving the shafts known to those of ordinary skill in the art would also be suitable.

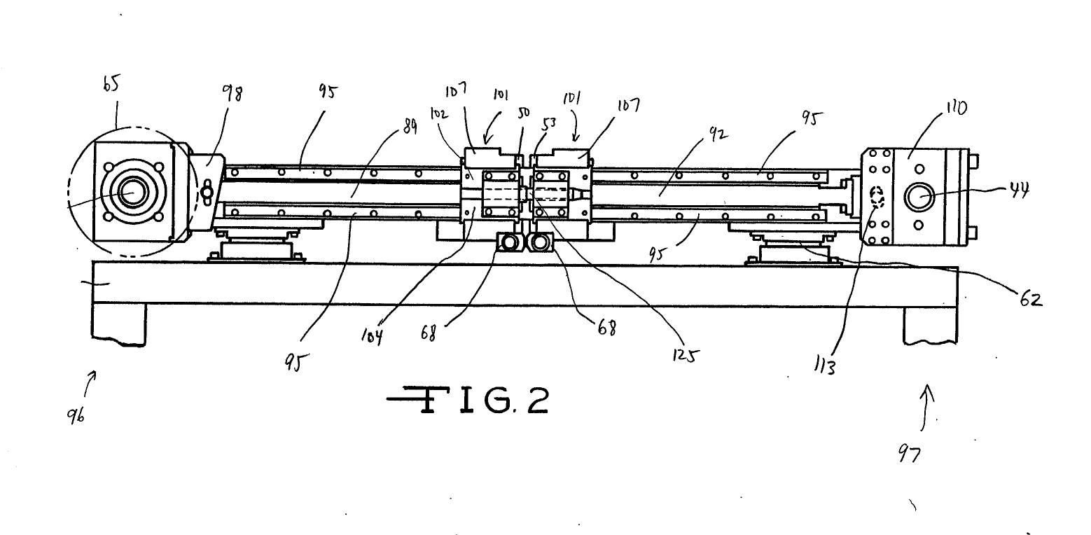

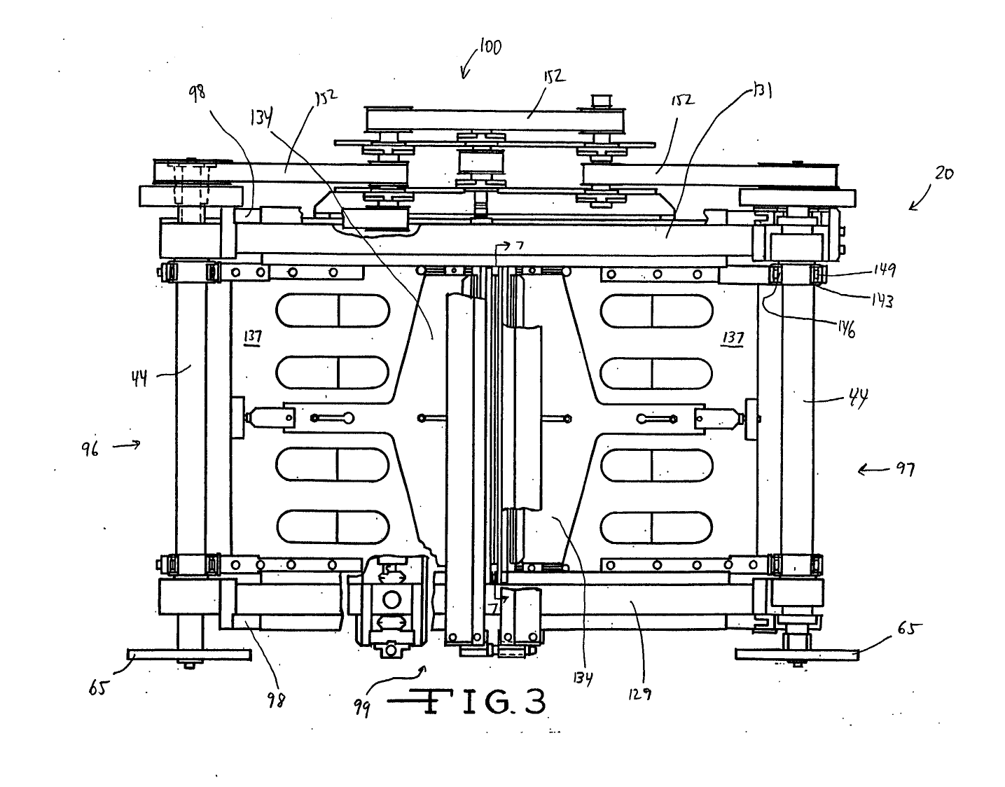

Turning to FIG. 2, the die mounting plates 50 and 53 are mounted to a pair of slides 89,92 that move inside a set of stationary gibs 95 that are positioned on both the right and the left hand sides of the apparatus 20. As shown in FIG. 3, the components shown in FIG. 2 on the left hand side 96 and right hand side 97 are present on both the front side 99 and the back side 100 of the apparatus 20. Since the components on the back side 100 of the apparatus 20 are the same, they are not described separately.

The die mounting plate 50 and die 51 on the left side of apparatus 10 are fixed during the operation of the apparatus 20. A tapered block 98 is removable and provides room for die mounting plate 50 and die 51 to be retracted by moving the slide 89. The die mounting plates 50, 53 are carried by frames 101 that are formed out of H-blocks 104 and cross members 107.

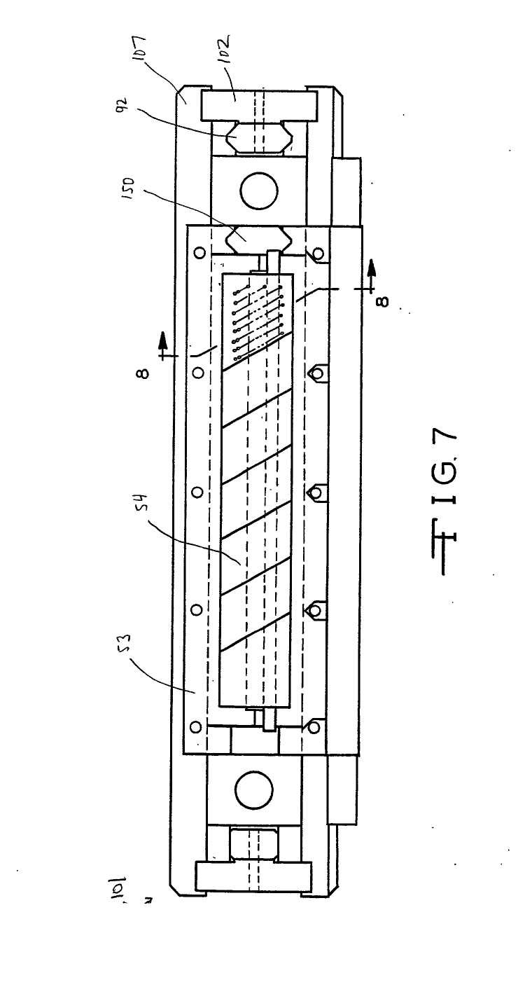

Referring to FIG. 7, the frame 101 on the right side moves the die mounting plate 53 toward and away from the die mounting plate 50 to form a stripper. The stripper action is provided by the slide 92.

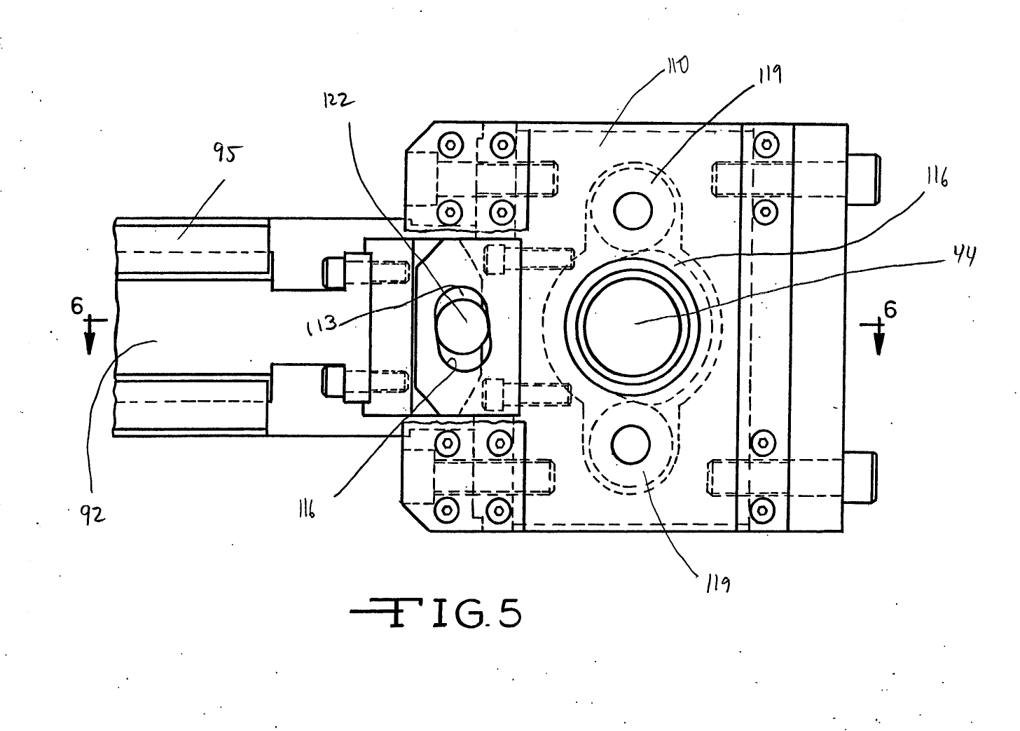

Referring to FIG. 5, the right slide 92 moves between the stationary gibs 95 according to a cam operated block 110 having an eccentric hole 113. The cam operated block 110 is driven up and down by a cam surface 116 rotated by cam shaft 44 and disposed between a set of rollers 119. The rotation of the cam surface 116 causes the rollers 119 to move up or down through a portion of each rotation of the cam shaft 44. Each time the cam surface 116 pushes the top roller 119 upward, the eccentric slot 113 moves upward which causes the pin 122 connected to the slide 92 to move the slide 92 inward to close the stripper. In contrast, when the cam surface 116 pushes down on the lower roller 119, the eccentric slot 113 moves downward causing the pin 122 and slide 92 to move away to open the stripper. The stripper movement covers a distance of approximately twenty-thousandths of an inch. The timing of the opening and closing of the stripper is thereby linked to the rotation of the cam shaft 44 through the cam surface 116.

Returning to FIG. 2, a mechanical interlock 125 ensures registry of the die plates 51 and 54. The interlock 125 (best shown in FIG. 14) includes a precision fit tab and opening 128.

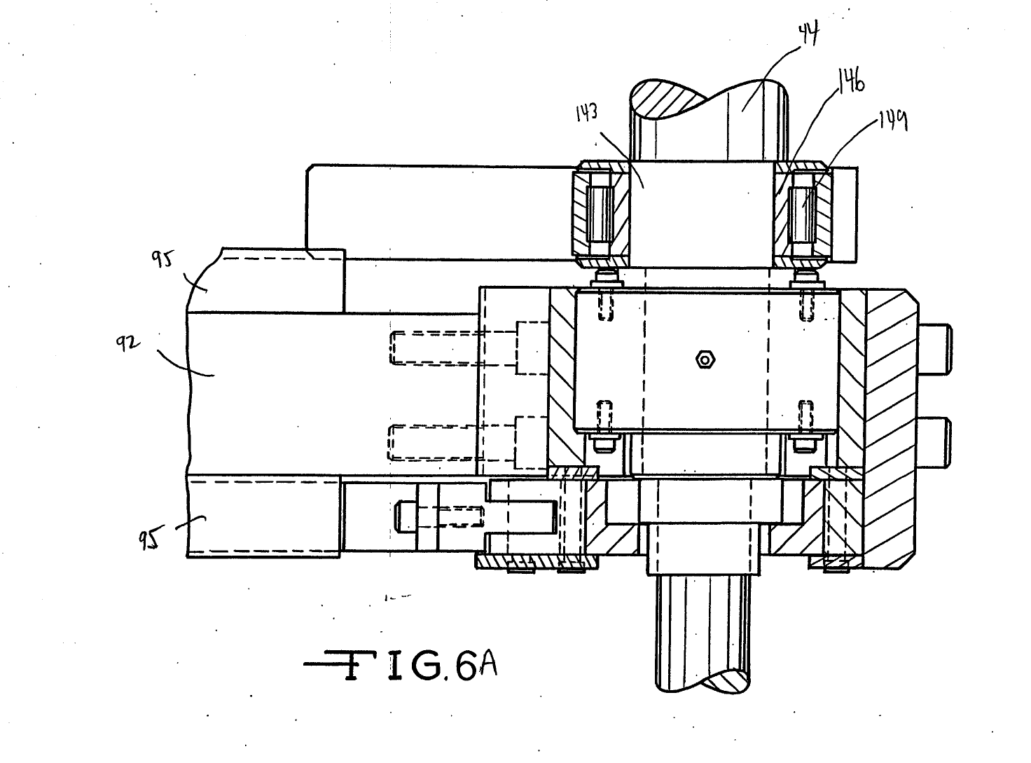

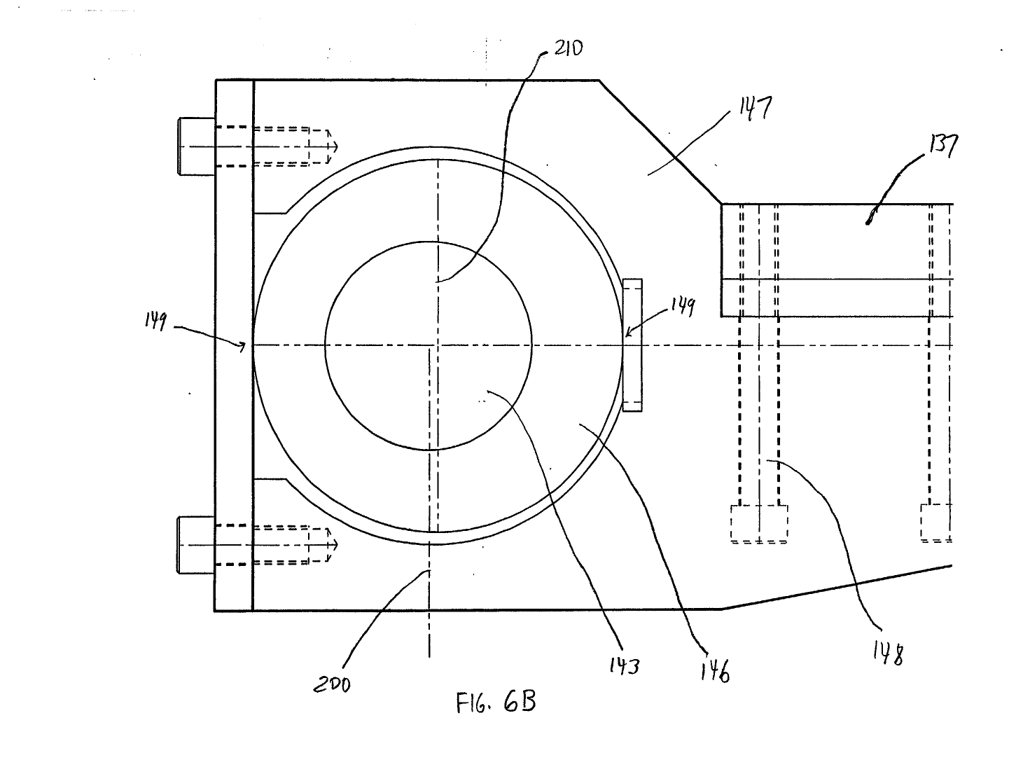

In FIG. 3, a set of tie bars 129, 131 connect the two sides of the apparatus 20 to help maintain the apparatus 20 perfectly square with regard to the tooling 41 and the punch rams 47. A T-shaped bar 134 is fastened to a square plate 137. The T-shaped bar 134 carries the punches 140 (shown in FIG. 8). The T-shaped bar 134 is driven off of the cam shaft 44 by an eccentric cam 143 mounted on the shaft 44 (best shown in FIG. 6A) that drives a roller bearing 146 (FIG. 6A) with a set of rollers 149 (FIG. 6A).

Referring to FIG. 6B, the roller bearing 146 is mounted inside a collar 147 that is connected to the plate 137 by suitable fasteners 148. The centerline 200 for the cam shaft 44 is shown in broken lines and the centerline 210 of the eccentric is also shown in broken lines. The inside of the collar 147 has bearing surfaces 149 that can be replaced if wear grooves are formed. Accordingly, the rotation of the eccentric 143 caused by rotation of the cam shaft 44 causes the roller bearing 146 to transfer the plate 137 horizontally.

The plate 137 drives the punches 140 on an independent set of slides 150 (shown in FIG. 7). Accordingly, as shown in FIG. 7, the die mounting plate 53 and die 54 are attached to the frame 101 which is moved by slide 92. The punches 140 are carried by the T-bar 134 which is moved by slide 150. The punches 140 travel approximately five millimeters during the punch stroke. Accordingly, the stripper movement and the punch stroke both operate off of the cam shaft 44, but are driven by different cams and different slides.

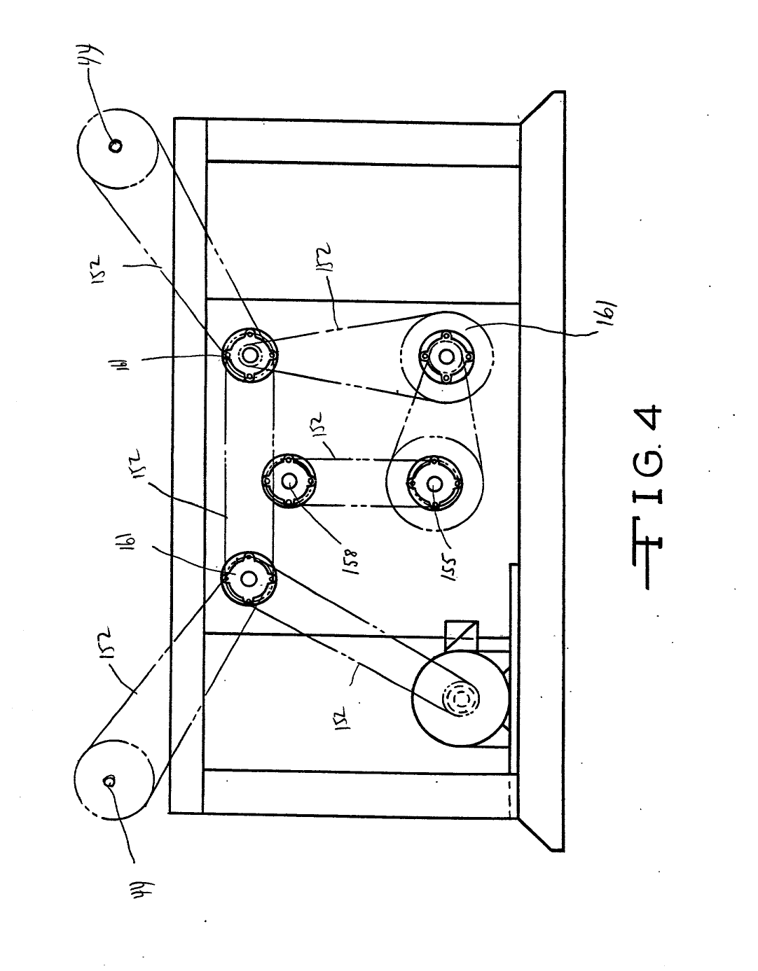

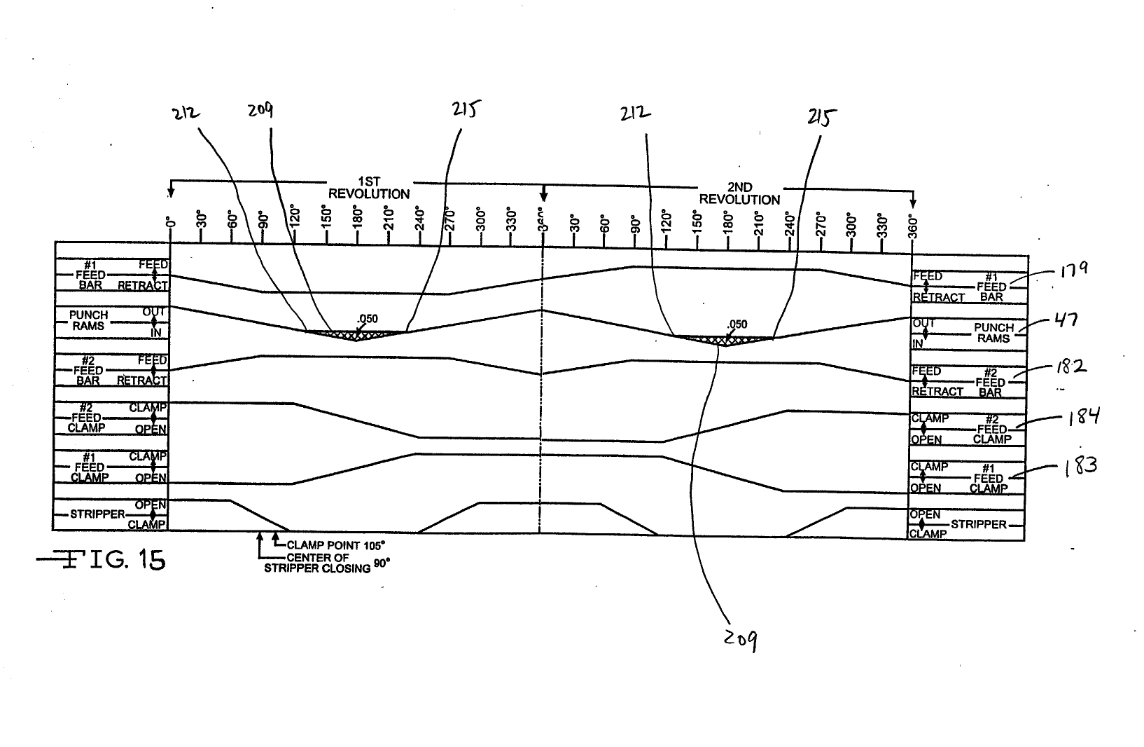

Returning to FIG. 3, the cam shafts 44 are driven from the same motor 86 and variable speed drive through a system of precision belts 152. In FIG. 4, a schematic of the drive system illustrates that belts 152 drive the cam shafts 44 at the same speed, and drive the gripper shafts 155, 158 at a second speed. The speed reducers 161 are designed according to the throughput of the line and the timing of the apparatus 20, as known to those of ordinary skill in the art. FIG. 15 illustrates a timing diagram for the compound punching apparatus which will be described in detail hereinafter.

In FIG. 8, the punches 140 are shown as they pass through the material 23 and produce a slug 71. The slugs 71 move in a column through a passageway 164 that leads to a vertical manifold 167 that connects to the evacuation tubes 68. The dies 51, 54 and the die mounting plates 50, 53 are shown in the stripper closed position. The stripper is closed during the entry into and removal of the punches 140 from the material 23 to provide support to the material, to maintain the very close tolerances, and to prevent undesirable deformations from occurring. The die 54 and die mounting plate 53 are attached to the H-blocks 104 which move toward and away from the stationary die 51 and die mounting plate 50.

Turning to FIG. 9, the punches 140 produce slugs 71 that have to be removed without jamming. When the slugs 71 are punched by the force of the ram 47, they tend to form a column that sticks together. By having a curved opening 170 with a relatively short radius, the column of slugs 71 is forced to break up as it conforms to the curve, and the curve reduces the likelihood of jamming. From the center outward on the left side, the components include the die 51, the die mounting plate 50, a vertical manifold 167, a punch holder 173, a punch head spacer 176, a back-up plate 178, and a punch ram 47. The punch ram 47 is mounted to the T-shaped bar 134 that is driven by the cam shaft 44 (FIG. 8).

Turning to FIGS. 10-13, a pair of grippers 74, 77 advance the materials 23 during a portion of each cycle of the apparatus 20. The material 23 advances through the apparatus 20 on an intermittent basis because the material 23 cannot be advanced when the stripper is closed or when the punches 140 are extending through the material 23 during the punch stroke. The grippers 74, 77 have gripper feed bars 179, 182 that are disposed one above the other, and they are coordinated with one another, such that they grip and feed in a “hand over hand” fashion. Both gripper feed bars 179, 182 move vertically up and down. Also, both gripper feed bars 179, 182 have clamps 183, 184 that close such that only one gripper feed bar 179, 182 is capable of conveying the material 23 at any given time. While one of the grippers 74 is conveying the material 23, the other gripper 77 is capable of being open and moving upward to get into position for its next cycle. Accordingly, the capability of repositioning one gripper 74 while the other gripper 77 is moving, eliminates dead time.

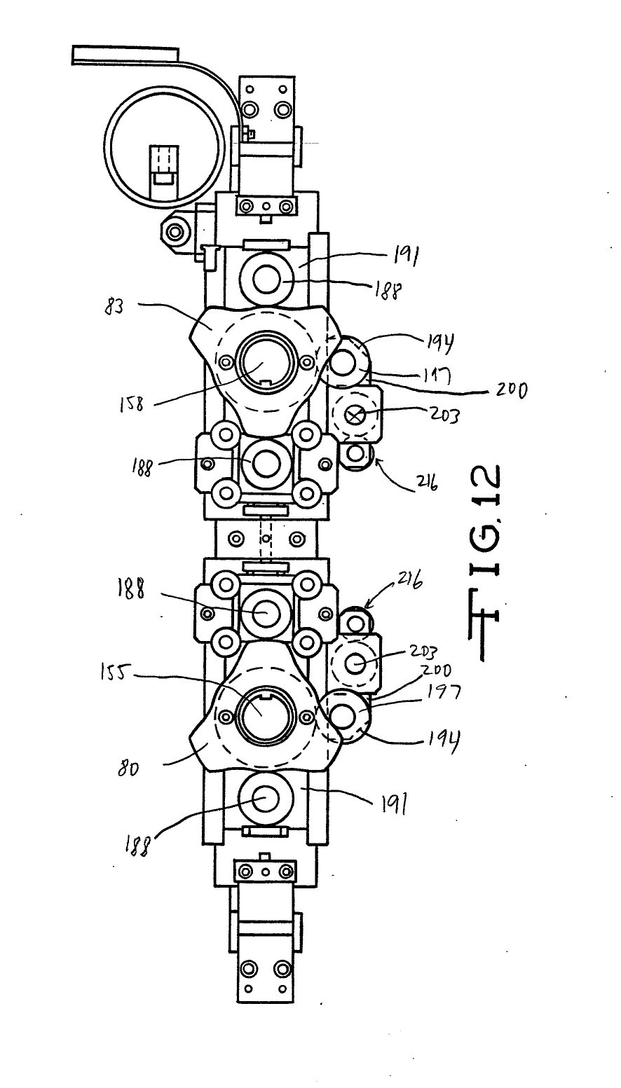

In FIG. 12, tricoidal cam 80 rotates on gripper shaft 155 and tricoidal cam 83 rotates on gripper shaft 158. The cam 80 moves a cam follower 185 by means of a pair of rollers 188. The rollers 188 are attached to an assembly 191 that moves up and down according to the position of the cam 80 which moves the gripper feed bars 179, 182 up and down. The rollers 188 are fixed relative to one another. The gripper shafts 155, 158 also control the opening and closing of the grippers clamps 183, 184 through a second cam surface 194. The gripper shaft 155 engages a cam wheel 197 that is attached to a member 200 that pivots about a pivot point 203. The opposite end 216 of the member 200 moves in and out to activate the clamping of the gripper 74.

Referring to the timing diagram in FIG. 15, the cycle for the apparatus 20 is shown for two revolutions of the cam shaft 44. The punch rams 47 are fully retracted at 0 degrees. The cross-hatched region 209 corresponds to the portion of the cycle when the punches 140 have entered the material 23 to punch out the perforation. Next, they travel forward a short distance and then start moving backward out of the material 23. The point 212 at the front of the region 209 is where the punch 140 enters the material 23. The point 215 at the back of the region 209 is where the punch 140 exits the material 23. During the time that the punches 140 are in the material 23, the material 23 cannot be advanced by the feed system. Accordingly, from a portion of the cycle just prior to the punches 140 entering the material 23 to the time when the punch 140 exits the material 23, the gripper feed bars 179, 182 are “flat lined” in the diagram, indicating that they are not moving. During this still period for the gripper feed bars 179, 182, the clamps 183, 184 are alternately opening and closing. For a fractional portion of the cycle while the punches 140 are inserted through the material 23, both clamps 183, 184 release the material 23. This short period provides a chance for the material 23 to adjust slightly so that if it becomes misaligned it is not locked in to misalignment by constant positive traction from the grippers 74.

The stripper closes prior to the punches 140 entering the material 23 and opens shortly after the punches 140 exit the material 23, such that the stripper is open when the material 23 is being advanced.

As indicated in the diagram, the gripper feed bars 179, 182 move in opposite directions such that while one is feeding (with its corresponding clamp closed), the other is moving upward (with its clamp open) into position for its next feed.

The timing of all of the movements is synchronized by the drive system which ties all of the shafts to a single motor 86.

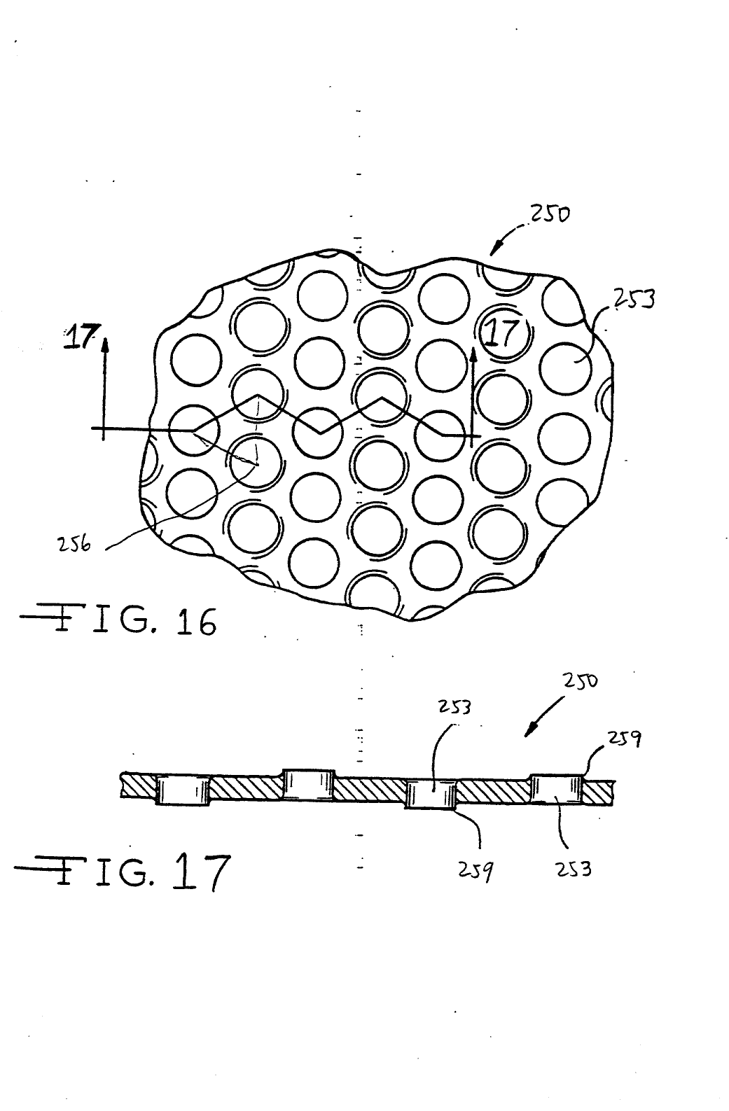

Turning to FIG. 16, a perforated substrate 250, preferably of an electrically conductive material, is formed using the compound punching apparatus 20 of the present invention. The perforations 253 are preferably disposed such that the centers 256 of any three adjacent perforations 253 form an equilateral triangle. Accordingly, each of the perforations 253 is equidistant from any adjacent perforation 253. In FIG. 17, the perforations 253 are formed such that adjacent perforations 253 are punched from opposite major surfaces of the material 23 as indicated by the burrs 259. In this manner, the adjacent perforations 253 introduce substantially equal and opposite stress forces into the material 23 that essentially cancel each other to provide a planar characteristic to the perforated substrate 250. The perforations 253 do not have to be made simultaneously to obtain this effect.

Accordingly, the present invention offers several advantages including a reduction in the amount of crossbow that is normally associated with wider materials. By uniformly alternating the perforations such that adjacent perforations are punched from opposite sides of the material, the stress forces produced at each perforation are essentially canceled by the adjacent perforation formed through the opposite major surface of the material.

By providing wider, flatter material, the present invention provides for faster production of high quality substrates for use in the production of electrochemical cells. The wider materials facilitate greater production by increasing the throughput without increasing the line speed. The perforated substrates produced by the present invention are suitable for use as current collector substrates that are laminated at high speeds with an electrode-active material to form current collectors.

It is contemplated that the compound punching apparatus may be suitable for processes outside of the electrochemical area. For example, the present invention would be suitable for any process where a thin substrate must be maintained as planar as possible for downstream coating, laminating or other processes where bowing of the material has to be minimized.

Another advantage of the present invention is that the hand over hand operation of the grippers provides for smooth operation of the feed system such that after the punches retract from the material, a pair of grippers is always in position to feed material. While the active gripper is feeding the material for the next punch, the inactive gripper is moving simultaneously into position for its next feed.

The present invention also advantageously provides a slug removal system that prevents clogs that can damage the tooling. The curvilinear entry path into the disposal tube forces the slugs to separate from one another such that they continue to feed into the disposal tube rather than jamming and backing up into the path of the punch.

The present invention also provides for precision timing of all of the cam movements by linking all of the shafts to a single motor and drive.

While the invention has been described in connection with certain preferred embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A compound punching apparatus for providing a perforated material having first and second major surfaces, the apparatus comprising:
a. a frame;
b. a first punching tool mounted on the frame and capable of forming first perforations into the first major surface of the material with the first perforations extending through the second major surface;
c. a second punching tool mounted on the frame and capable of forming second perforations into the second major surface of the material with the second perforations extending through the first major surface;
d. a first die mounted on the frame and having a set of openings corresponding to the first punching tool;
e. a second die mounted on the frame opposite the first die and having a set of openings corresponding to the second punching tool, the second die capable of reciprocal motion toward and away from the first die such that the second die forms a stripper;
f. a feed system having at least two grippers capable of advancing the material through the apparatus;
g. a drive system capable of providing motion to the first punching tool, the second punching tool, the second die, and the gripper; and,
h. a motor connected to the drive system.

2. The apparatus of claim 1, wherein each gripper has a feed bar and a clamp.

3. The apparatus of claim 2, wherein the drive system includes at least two gripper shafts.

4. The apparatus of claim 3, wherein the gripper shafts drive a tricoidal cam that is engaged with the feed bars such that rotation of the shaft produces reciprocating motion of the feed bars.

5. The apparatus of claim 3, wherein the gripper shafts drive a cam that is engaged with a cam follower, the cam follower being linked with a pivoting member, the pivoting member rotating in response to the movement of the cam follower to actuate the clamp onto the material.

6. The apparatus of claim 2 wherein the grippers feed the material in alternating fashion.

7. The apparatus of claim 6, wherein the feed bars move simultaneously in opposite directions for at least a portion of the cycle such that while one gripper is clamped and advancing the material the other gripper is repositioning for its next feed.
